(19) United States
(12) Patent Application Publication
(10) Pub. No.: US 2025/0272969 A1
(43) Pub. Date: Aug. 28, 2025

(54) IDENTIFICATION OF OBJECTS IN DIGITAL IMAGE

(71) Applicant: Adobe Inc., San Jose, CA (US)

(72) Inventors: Sachin Soni, New Delhi (IN); Prasenjit Mondal, Midnapore (IN)

(73) Assignee: Adobe Inc., San Jose, CA (US)

(21) Appl. No.: 18/586,491

(22) Filed: Feb. 25, 2024

(51) Int. Cl. G06V 10/94; G06F 3/0484; G06T 7/12; G06T 7/73; G06V 10/26; G06V 10/36; G06V 10/44; G06V 10/77; G06V 10/776; G06V 20/70

(52) U.S. Cl. CPC G06V 10/945; G06F 3/0484; G06T 7/12; G06T 7/73; G06V 10/26; G06V 10/36; G06V 10/44; G06V 10/7715; G06V 10/776; G06V 20/70; G06T 2200/24; G06T 2207/20092

(57) ABSTRACT

Object identification techniques from a digital image are described. In an implementation, edges of an object are determined by analyzing gradients from a digital image. A structure of the object is computed by detecting line segments from the digital image. A boundary of the object is defined based on the edges and the structure. A display of the object is edited in a user interface based on the boundary using an edit operation.

### BACKGROUND

Identification and selection operations involving objects in digital environments as part of digital image creation is quite common. Web pages, digital presentations, digital documents and so on, for instance, often include various objects such as links, sections of text, figures, diagrams, and the like, which can be identified and selected by a user. When these objects are individually added to a digital image, it is usually quite easy to make these objects selectable by a user.

However, when multiple objects are provided in a digital image without predefined separation, difficulty in selection of these objects increases. For example, a presentation in portable document format (PDF) can include charts, text, and other objects that have overlaps, irregular spacing, and so on and as such are difficult to individually select using conventional techniques. Accordingly, these difficulties result in user frustration and inefficient consumption of computational resources, which may be exacerbated when implemented as part of digital services that support thousands and even millions of instances of user access.

### SUMMARY

Techniques for identifying, bounding, editing, and otherwise manipulating objects in a digital image are described. In one or more examples, techniques are implemented in relation to a digital image to identify (e.g., bound) one or more objects are included in the digital image. The techniques are configured to utilize a variety of functionalities. Examples of these functionalities include instance segmentation of objects, structure identification of objects, element identification of objects, object association, and other techniques. The techniques provide data in the form of maps, structure, elements, classifications, edges and so forth for aiding in defining and bounding the objects of the digital image. Once the objects are identified and bounded, edit operations can be performed on the objects such as snapping, alignment, visual guide operations and the like.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ digital systems and techniques for identifying and manipulating objects of a digital image.

FIG. 2 depicts an example system for identifying and manipulating objects of a digital image in accordance with techniques described herein.

FIG. 3 is a chart that illustrates an example of a model that includes an object identification module and a position control module for performing identification and manipulation of objects within a digital image in accordance with techniques described herein.

FIG. 4 is an illustration of an example of an instance segmentation module that is part of the object identification module of FIG. 3.

FIG. 5 illustrates examples of digital images upon which a segmentation operation has been performed in accordance with techniques described herein.

FIG. 6 is an illustration of an example of a structure identification module that is part of the object identification module of FIG. 3.

FIG. 7 illustrates an example of an architecture suitable for performance of structure identification of objects of a digital image in accordance with techniques described herein.

FIG. 8 illustrates an example of a digital image and examples of feature maps generated by performance of structure identification of the digital image in accordance with techniques described herein.

FIG. 9 is an illustration of an example of an element identification module that is part of the object identification module of FIG. 3.

FIG. 10 illustrates an example of a digital image and an example of a gradient image formed from the digital image in accordance with techniques described herein.

FIG. 11 illustrates an example of a binarized gradient image and an example of a binarized grey scale image formed from the digital image of FIG. 10 in accordance with techniques described herein.

FIG. 12 illustrates the digital image of FIG. 10 and an example of a line segment structure image formed from the digital image in accordance with techniques described herein.

FIG. 13 illustrates an example of a network architecture of an example of a machine learning model suitable for performing color-based segmentation on a digital image in accordance with techniques described herein.

FIG. 14 illustrates examples of segmentation maps of digital images that have been formed by performing color-based segmentation on the digital images in accordance with techniques described herein.

FIG. 15 is a flowchart of an example of a methodology for linking multiple objects together for forming a single object from the multiple objects according to techniques described herein.

FIG. 16 is a flowchart of an example of a methodology for performing an edit operation based on a defined boundary of an object in a digital image.

FIG. 17 illustrates an example system that includes an example computing device that is representative of one or more computing systems and/or devices for implementing the various techniques described herein.

### DETAILED DESCRIPTION

### Overview

Object selection in a digital environment is a functionality that is implemented to allow manipulation (e.g., move, rotate, snap, delete, copy, and otherwise adjust) of objects within that environment or move those objects to another environment, e.g., a different digital image. For example, a presentation often includes objects such as text, graphs, pictures, and so on that are manipulable via a user interface to achieve a desired arrangement for the presentation.

The ability to quickly and accurately select objects for manipulation in the digital image provide a basis for accomplishing various tasks in a digital environment. In contrast, the inability to make such selections is typically counterproductive and increases inefficiencies both to a user as well as computing devices that implement the digital environment. Consider a scenario in which an object (e.g., a graph) included in a digital image is to be moved into a separate presentation without moving the entire digital image. If the graph is not selectable within the digital image, a user is then tasked with recreating the graph for inclusion into the presentation. Such a recreation may involve significant consumption of resources that could be utilized elsewhere (e.g., both within a single client device or elsewhere as part of a service provider system) if an ability is supported that simplifies selection and movement of the graph into the presentation.

Consider another scenario where a first object is selected, which is part of a second larger object. For example, imagine that the aforementioned graph includes a text object (i.e., an object that is formed of words and letters) and a graphic object, e.g., a picture of a graph, animal or otherwise. In order to move the text object into a presentation or move the text object out of the graph, conventional techniques typically involve repeated trial-and-error for selection to manipulate or significant amounts of time to recreate the text component.

Thus, as described above if an object is provided as part of a digital image without having a predefined separation within the digital image, it is difficult using conventional techniques to identify boundaries of the object. This difficulty increases in instances in which the object is relatively complex in shape or configuration. As such, it is also difficult using conventional techniques to then select those objects. Further yet, difficulties are experienced in conventional techniques that involve segmenting objects into categories, e.g., in scenarios in which the objects have different types within the digital image.

Accordingly, techniques are described for identifying objects within a digital image. These techniques as implemented by a digital image processing system support multiple functionalities usable to identify combinations of parameters (e.g., two or more of boundaries, edges, categories, structures, associations, links, and the like) of objects of a digital image. The parameters, once identified by the digital image processing system, are usable to aid identification of the objects, subsequent use of editing operations, and so forth. The boundary, for instance, enables execution of an edit operation involving the object based on the boundary in a manner that addresses the above technical challenges.

In one or more implementations, for instance, these functionalities are usable to identify objects that do not have predefined separation between the object within the digital image, which is not possible using conventional techniques. The parameters of the objects are usable by the digital image processing system to identify boundaries of the objects. Bounding indications may then be output (e.g., visual guides) by the digital image processing system to aid user selection of the objects of the digital image, perform one or more editing operations (e.g., moving or snapping) on the one or more objects, and so forth. Further discussion of these and other examples is included in the following sections and shown in corresponding figures.

In the following discussion, an example environment is first described that employs examples of techniques described herein. Example procedures are also described which are performable in the example environment and other environments. Consequently, performance of the example procedures is not limited to the example environment and the example environment is not limited to performance of the example procedures.

### Example Environment

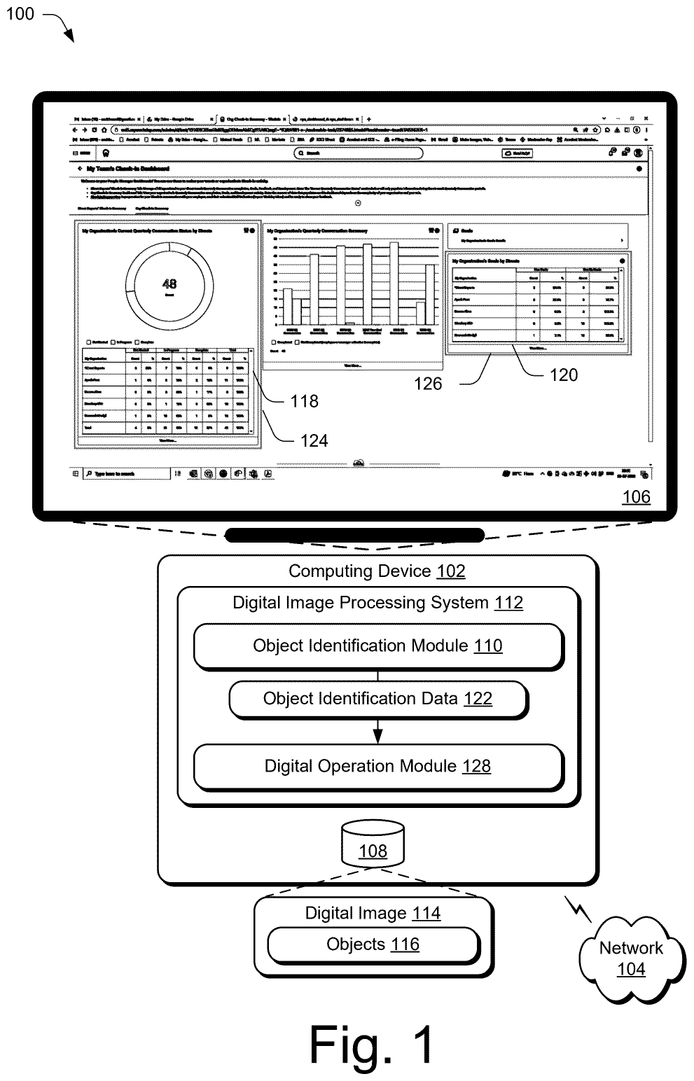

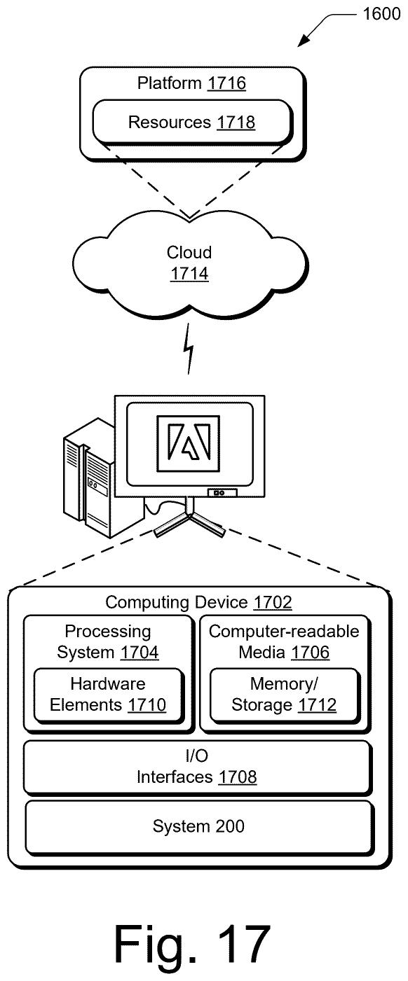

FIG. 1 is an illustration of an environment 100 in an example implementation that is operable to employ digital systems and techniques for object identification using a digital image as described herein. The illustrated environment 100 includes a computing device 102 connected to a network 104. The computing device 102 is configurable as a desktop computer, a laptop computer, a mobile device (e.g., assuming a handheld configuration such as a tablet or mobile phone), and so forth. Thus, the computing device 102 is capable of ranging from a full resource device with substantial memory and processor resources (e.g., personal computers, game consoles) to a low-resource device with limited memory and/or processing resources (e.g., mobile devices). In some examples, the computing device 102 is representative of a plurality of different devices such as multiple servers utilized to perform operations “over the cloud” as further described in relation to FIG. 17.

The illustrated environment 100 also includes a display device 106 that is communicatively coupled to the computing device 102 via a wired or a wireless connection. A variety of device configurations are usable to implement the display device 106, e.g., a light emitting diode (LED), organic light emitting diode (OLED), and so forth.

The computing device 102 includes a storage device 108 and an object identification module 110, which is part of a digital image processing system 112. The storage device 108 is configured using a computer-readable storage medium (e.g., non-transitory) for storing a digital image 114, such as digital artwork, digital videos, digital media, digital presentations, and so forth. The digital image 114 includes one or more objects 116, which are configurable as raster object, vector objects, text, charts, graphs, and so forth.

An example of the digital image 114 is displayed on a screen of the display device 106 within a user interface. The digital image 114, in one or more examples, is configurable in a manner such that object 116 are not individually selectable using conventional techniques. In other words, there are no bounding indications provided for the objects 116, examples of which are illustrated as objects 118 and 120.

Accordingly, the object identification module 110 is configured to perform digital operations on the digital image 114 to produce object identification data 122 that helps identify objects 118, 120 in the illustrated example of the digital image 114. The object identification module 110 is also configured to generate indications 124, 126 (e.g., specified boundaries) of respective objects 118, 120 as visual indications, thereby indicating successful selection of the objects 118, 120. A digital operation module 128 is then utilized to control edit operations, examples of which include operations involving positioning of the objects 116 based on the object identification data 122. Examples of edit operations that are executable by the position control module 128 as part of position control include snapping operations, alignment operations, and visual guide operations, further description of which is included in the following discussion and shown in corresponding figures.

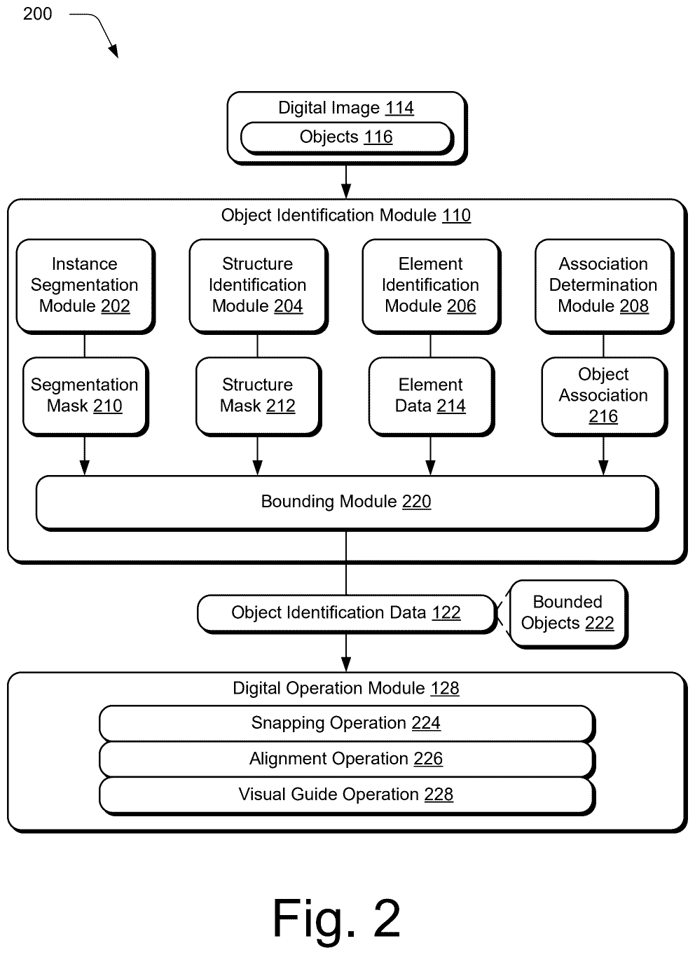

FIG. 2 depicts a system 200 in an example implementation showing operation of the object identification module 110 of FIG. 1 in greater detail. The example system 200 is configured to generating object identification data 122 based on the digital image 114. The object identification data 122, for instance, is configured to bound the objects 116. As used herein, the term “bound” and its conjugations refer to establishing boundaries of objects 116 and objects within those objects 116. It shall be understood that the term “object” as used herein can be an object or an object within an object unless otherwise specifically stated.

The system 200 includes the object identification module 110 includes a plurality of modules that are representative of functionalities executable by the computing device 102 to generate the object identification data 122. Illustrated examples of which include an instance segmentation module 202, a structure identification module 204, an element identification module 206, and/an association determination module 208. The instance segmentation module 202 is configured to identify and classify objects of the digital image 114 through one or more segmentation techniques through generation of a segmentation mask 210. The structure identification module 204 is configured to identify the overall shape of objects and the layout of object within those objects and from this, form a structure mask 212. The element identification module 206 is configured to determine and/or defined elements of objects for aiding in defining objects to generate element data 214. The association determination module 208 is configured to aid in determining one or more objects that are part of an overall object as part of determining an object association 216. Although the illustrated configuration of the object identification module 110 is desirable for multiple implementations of object identification within a digital image, however, it shall be understood that, for other implementations, the various modules can be combined, separated, used, or not used as desired for achieving objectives described herein.

Thus, one or any combination of the instance segmentation module 202, structure identification module 204, element identification module 206, and/or association determination module 208 produce data that aids in identifying objects within a digital image 114. Combinations of this data are therefore usable by the object identification module 110 as part of increasing accuracy in the identification of objects 116 within the digital image 114. The instance segmentation module 202, as described above, is shown to produce segmentation masks 210 of objects within a digital image that are usable to help identify and classify objects. The structure identification module 206 is shown to produce structure masks 212 of objects within a digital image that are usable as a basis to determine boundaries and shapes of objects within a digital image as well as determine boundaries and shapes of object within other objects. The element identification module 206 is shown to produce structure element data 214 to define elements of objects within a digital image 114, e.g., line segments, gradients, and the like. The association determination module 206 is illustrated as producing data describing an object association 216 of objects within a digital image to assist in identification and association of objects that “belong” together for forming a group, e.g., a text and graph objects that are identified as belonging together because the text describes the graph.

The data from the instance segmentation module 202, structure identification module 204, element identification module 206, and/or association determination module 208 is illustrated as output to a bounding module 220 of the object identification module 110. The bounding module 220 is configured to generate the object identification data 122, e.g., as bounded objects 222).

Once the objects 116 of a digital image 114 have been identified and/or defined by the object identification module 110, the objects may then be subject to further operations as performed by the digital operation module 128. Examples of these operations are illustrated as including a snapping operation 224, alignment operation 226, and visual guide operation 228. These operations are a few of the operations that may be implemented by the digital operation module 128.

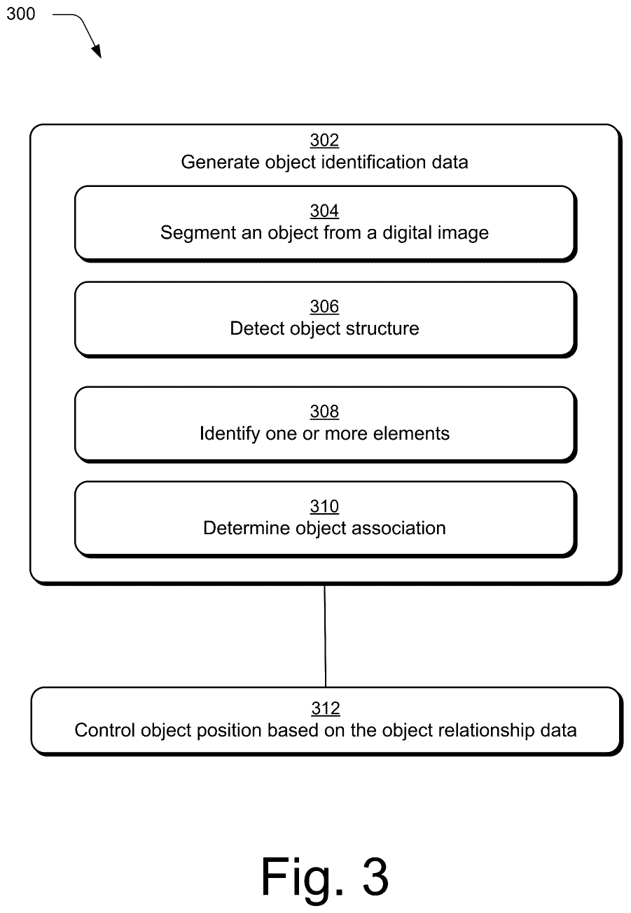

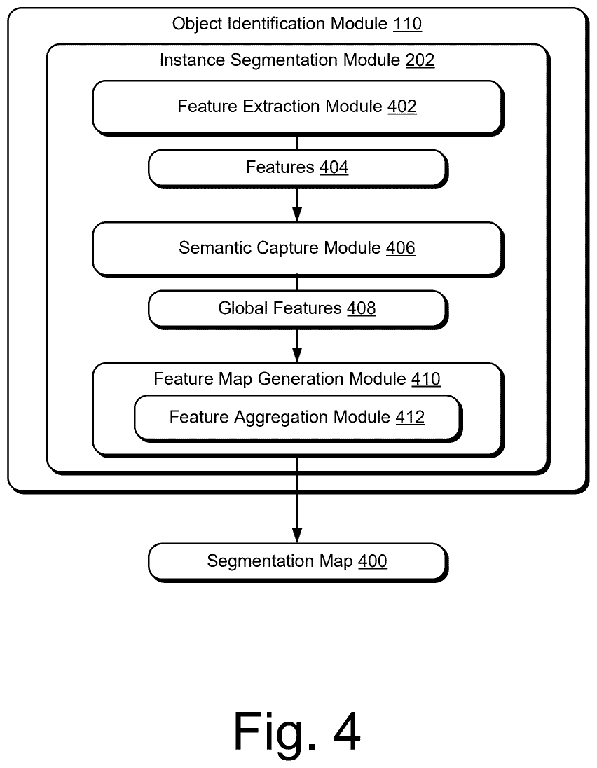

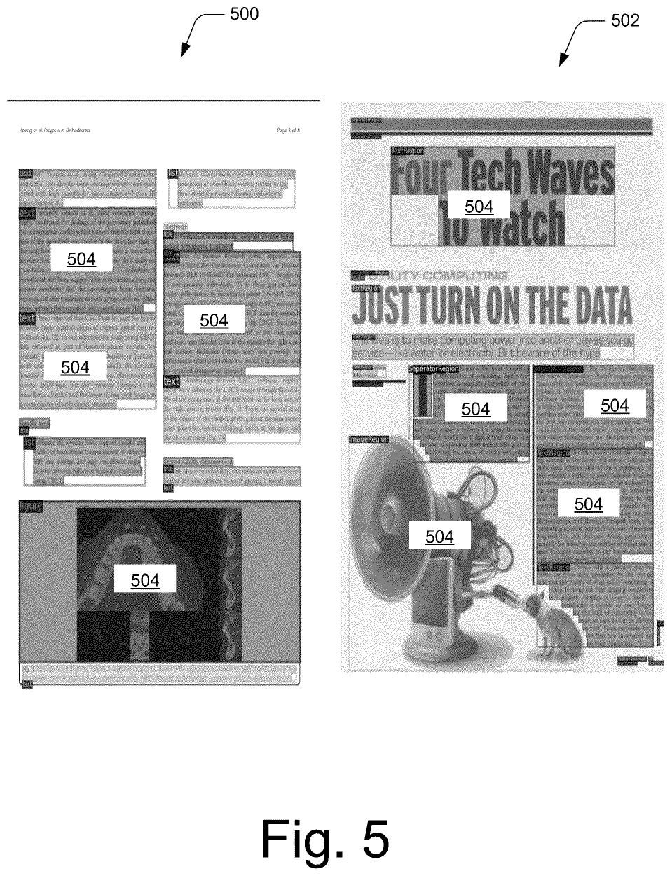

FIG. 3 illustrates an example 300 of an overall technique that includes multiple permutations usable to generate the object identification data 122. According to the illustrated technique, as shown in block 302, various object identification data is produced. As an example, as shown in block 304, one or more objects of a digital image are segmented to produce data such as segmentation masks to aid classification or otherwise define objects of the digital image as further described in relation to FIGS. 4 and 5.

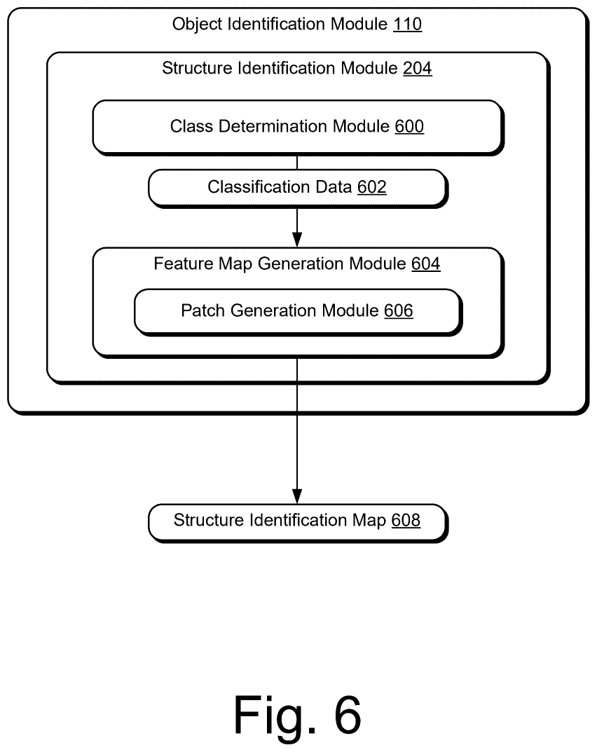

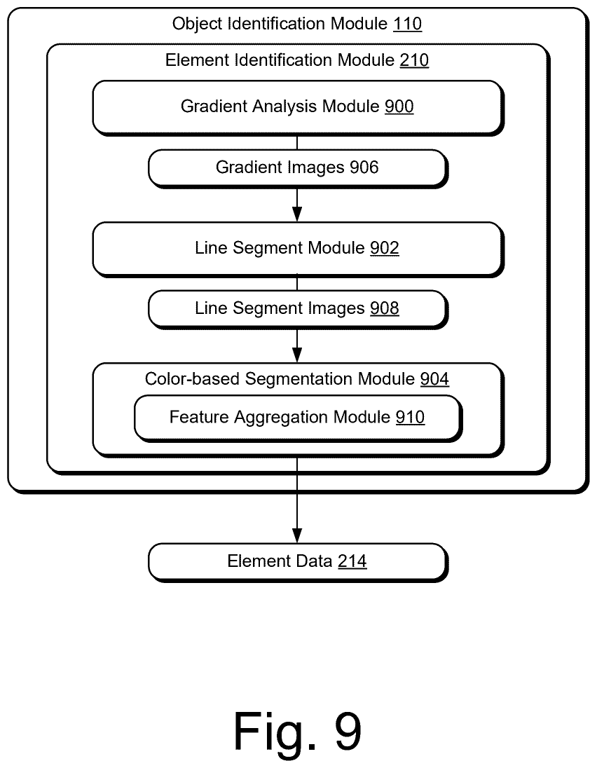

As another example, as shown in block 306, structure of one or more objects of a digital image are detected to produce data such as structure masks to help define the shape and overall structure or otherwise define objects of the digital image as further described in relation to FIGS. 6-8. As yet another example, as shown in block 308, element data of one or more objects of a digital image is determined to aid definition of objects of the digital image as further described in relation to FIGS. 9-14.

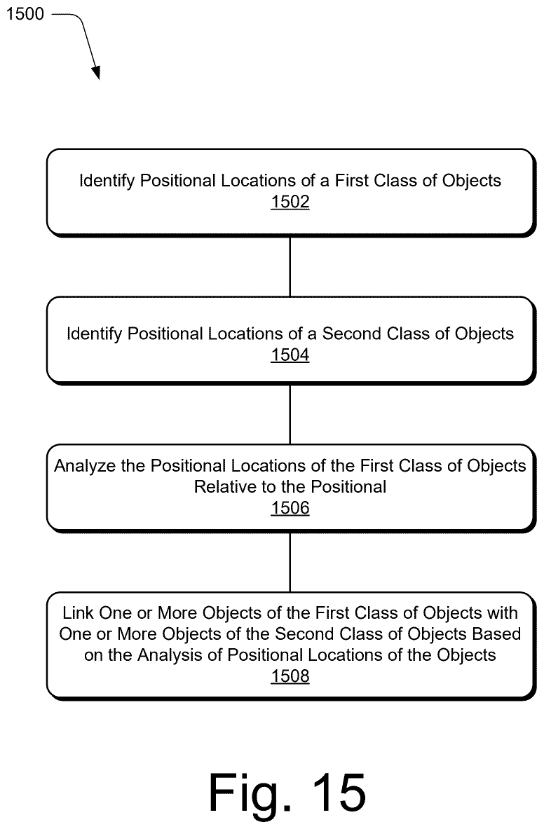

As still another example, as shown in block 310, object association data of one or more objects of a digital image can be determined to associate objects that belong together to form other objects as further described in relation to FIG. 15. This data can then be employed to help bound objects of a digital image and/or help control positions of objects as shown in block 312. With this explanation, details are provided below and herein on the development and use of such object identification data.

### Instance Segmentation

FIG. 4 illustrates a block diagram of an example showing operation of the instance segmentation module 202 of FIG. 2 as part of the object identification module 110 for performing instance segmentation on a digital image. In one or more implementations of identification and/or bounding of objects of digital images, one or more segmentation techniques are performed on a digital image. As one example, instance segmentation is performed on a digital image to identify and categorize one or more objects in the digital image and one or more components (other objects) of those objects. Instance segmentation is typically performed by the instance segmentation module but may alternatively be performed by alternative modules and/or alternative techniques, unless otherwise specifically stated.

Generally, instance segmentation involves identifying instances of objects or components of an object that are present in a digital image and belong to a segment class. Instance segmentation typically involves multiple segment classes and the objects belonging to each segment class are identified and classified into their respective segment classes. As output, if desired, instance segmentation can provide an instance segmentation map that identifies each object and its respective segment class.

In an example, the instance segmentation module 202 utilizes a machine learning model and, in particular, a hybrid convolutional neural network (CNN) based transformer pipeline. The instance segmentation module 202 is configured to identify objects of a digital image 114. The instance segmentation module 202 then creates an instance segmentation map 400 of the digital image 114 (as an example of segmentation mask 210) that identifies the objects as masks or patches.

To do so, the instance segmentation module 202 predicts the segment class of each of the objects on a per-patch basis. The instance segmentation module 202 includes a feature extraction module 402 for identifying local features of objects of a digital image. As an example, the feature extraction module 402 is formed using a neural network for aiding in identifying objects of a digital image. The neural network is configurable as a convolutional neural network that includes a feature pyramid network (FPN) for aiding in identifying and classifying the objects of a digital image 114. In particular, the neural network identifies local features 404 of the objects 116 for aiding and classifying those objects 116.

The instance segmentation module 202 also includes a semantic capture module 406 for capturing semantic information and classifying objects of a digital image. The semantic capture module can include, for example, a transformer which employs semantic reasoning on the features of the digital image for aiding in identifying and classifying the objects of the digital image. In particular, the transformer identifies global features 408 of the objects. It is contemplated that the transformer is operable in conjunction with functional heads (e.g., a category head and a kernel head) to assign the objects 116 and particularly pixels of the objects to the segment classes.

The instance segmentation module 202 is also illustrated as including a feature map generation module 410. The feature map generation module 410 includes a feature aggregation module 412 (e.g., a layer-wise feature aggregation module) configured to compound and aggregate feature representations obtained from the neural network and the transformer to generate a final feature map. Then, a dynamic convolution activity is performed between the final feature map and a corresponding convolution kernel from the kernel head to obtain the predicted segmented instances of the objects in the digital image 114.

The output of applying instance segmentation to the digital image via the instance segmentation module 202 or otherwise performing instance segmentation is typically a segmentation map 400 of a digital image that identifies the objects of the digital image segmented into segment classes. FIG. 5 illustrates two different instances of segmentation maps 500, 502 on which, segmentation has been performed to identify multiple objects, several of which have been labeled with numeral 504 in the illustrated example. In the instance segmentation maps 500, 502, the objects 504 are identified by highlighting or masks with shades of grey and the different shades of grey indicate a class segment to which the respective objects 504.

### Structure Identification

Structure identification is another segmentation technique that is usable additionally or alternatively relative to the other segmentation techniques described herein for aiding in identification and/or bounding of objects of a digital image. Structure identification is typically performed by the structure identification module 204 but may alternatively be performed by alternative modules and/or alternative techniques.

In one or more implementations, the structure identification module 204 analyzes pixels of a digital image to determine which objects (e.g., trees, signboards, pedestrians, roads, buildings, cars, sky, etc.) the pixels belong, and more particularly classes associated with the objects. With reference to FIG. 6, this analysis is performed by a class determination module 600 within the structure identification module 204. Structure identification is performable on each of the pixels of a digital image or a sub-set of pixels of the digital image to determine which pixels are part of classes associated with the various objects of a digital image. In turn, the analyzed pixels are labeled with the class of object that the pixels help compose. In the illustrated structure identification module 204, the class determination module 600 outputs classification data 602, which is then used by a feature map generation module 604. The feature map generation module 604 works in conjunction with a patch generation module 606 that creates a structure identification map 608 that includes objects and objects within objects identified by patches or masks such that the structure of the objects can be identified.

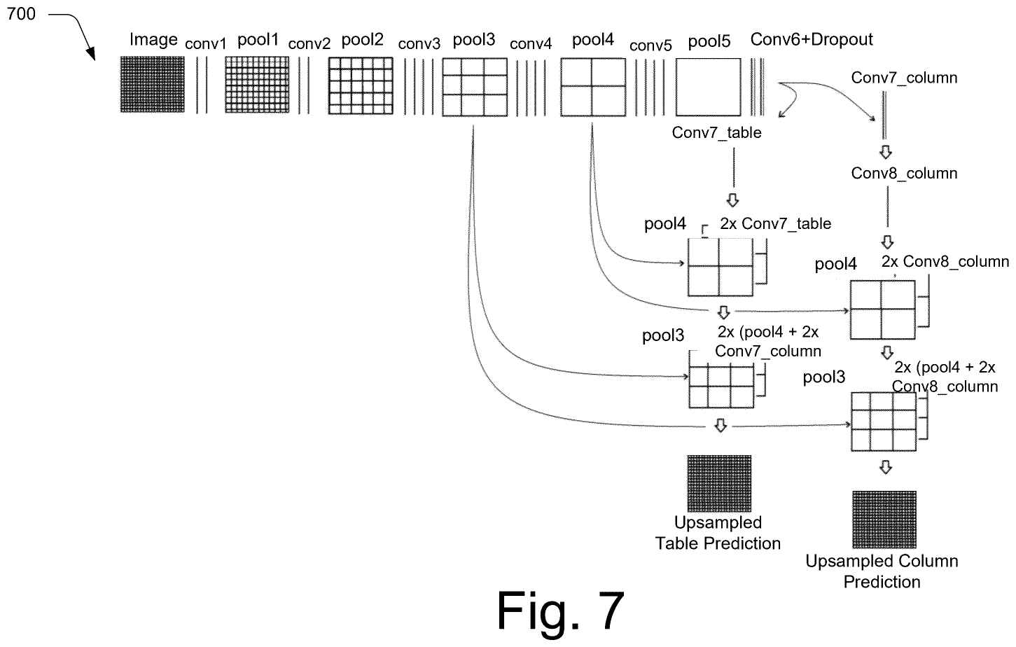

FIG. 7 illustrates an example of an architecture 700 useful for structure identification and/or the structure identification module 204. The architecture 700 shown is designed for identification of structures of tables, and more particularly regions of tables, but is also designable for identification of other object structures.

In the illustrated example, the structure identification module 204 is based on a machine learning algorithm, which is shown as a deep learning framework for region segmentation, e.g., table region segmentation. The structure identification module 204 includes an encoder network and a decoder network. The encoder network includes a combination of convolution, rectified linear unit (ReLU) and pooling layers that down-sample a spatial resolution of the pixels of the digital image to develop lower-resolution feature mappings. The down-sampled feature mappings from the encoder network are then passed through one or more (e.g., two) conv2D layers, and again processed through one or more “1×1” conv2D layers. The decoder network receives the lower-resolution feature mappings and are upsampled into a full-resolution feature map.

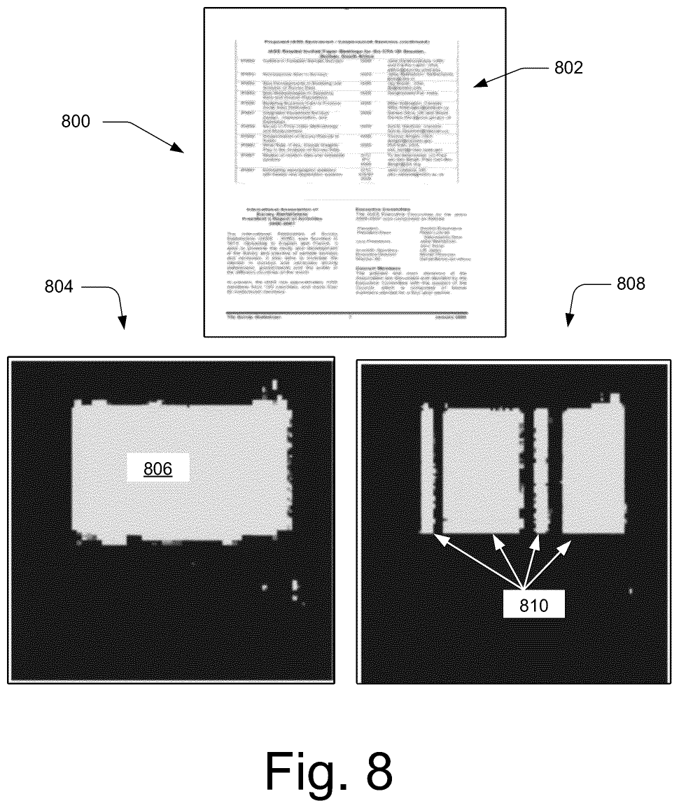

The full-resolution feature map is configurable to provide patches or masks of objects showing the boundaries of the objects upon which the structure identification is performed. In this way, the objects are identified, and knowledge of the location and boundaries of the objects is provided. FIG. 8 illustrates a digital image 800 that includes a table 802 upon with structure identification has been performed. As can be seen, a first feature map 804 produced by structure identification provides a mask/patch 806 of the table 802 as an object of the digital image 800. As can also be seen, a second feature map 808 produced by structure identification provides masks/patches 810 of columns of the table 802 as objects of the digital image 800.

### Element Identification

In one or more implementations of identification and/or bounding of objects of digital images, an element identification technique is usable in addition and/or alternative to other techniques described herein. Generally, element identification is implementable using gradient analysis, line segment structure analysis and/or color-based segmentation to help identify and define objects in a digital image. As before, element identification can include any combination of these techniques or just one element identification technique for identification and/or bounding of objects of digital images. Element identification is typically performed by the element identification module 206 but may alternatively be performed by alternative modules and/or alternative techniques. With reference to FIG. 9, the element identification module 206 can include one or more of a gradient analysis module 900 for performing gradient analysis, a line segment module 902 for performing line segment structure analysis and/or a color-based segmentation module 904 for performing color-based segmentation. The output of the gradient analysis is typically one or more gradient images 906, which are altered images based upon original images for which objects are being identified and/or determined. The output of the line segment module 902 is one or more line segment images 908. The color-based segmentation module 904 is configurable to employ a feature aggregation module 910 which along with the output of the other modules is usable by the element identification module 206 to form the element data 214.

Gradient analysis can be employed as part of element identification or otherwise or can be used additionally or alternatively used with other techniques described herein for aiding in identification and/or bounding of objects of a digital image. In one or more implementations, the gradient analysis module 900 or other module analyzes the pixels of a digital image to determine edges of objects of the digital image. Gradient analysis can be performed on each of the pixels of a digital image or a sub-set of pixels of the digital image to determine which pixels are part of edges of the various objects of a digital image. In this way, edges of the various objects of the digital image can be identified.

Generally, gradient analysis includes measuring a degree of change in color at pixels of the digital image as the digital image is traversed in one or more selected directions. Typically, this measurement is performed as the image is traversed in a first direction (e.g., an “x” direction) and in a second direction (e.g., a “y” direction) and values are assigned to the pixels based upon the degree of change in color at the respective pixels, e.g., in relation to a color space. The first direction can be orthogonal or otherwise configured relative to the second direction.

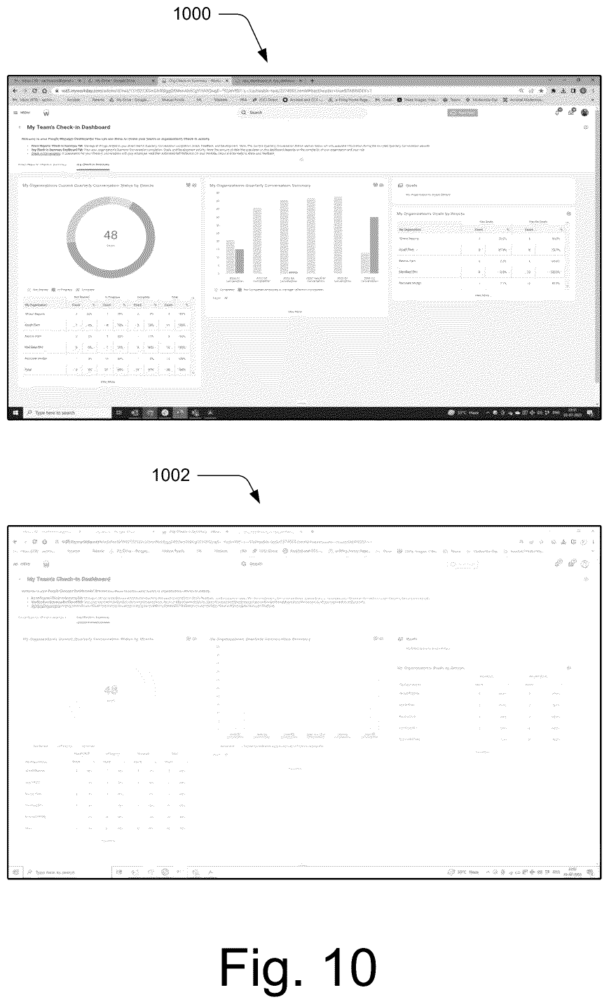

In this process, pixels associated with relatively large gradient values are identified as edge pixels, e.g., over a defined threshold amount of change. Then, cooperatively, the edge pixels identify edges as elements of objects in the digital image. Gradient analysis can, for example, be performed by convolving the digital image, particularly the pixels of the digital image, with a filter (e.g., a Sobel filter). From this analysis, gradient images are created. FIG. 10 shows an example of a digital image 1000 and a gradient image 1002 produced by gradient analysis of the digital image 1000. One example of an edge detector suitable for performing at least a portion of the gradient analysis and determining the edges of objects in a digital image 1000 is a Canny edge detector.

The gradient analysis can additionally or alternatively include one or more connected component analyses that can be performed upon the digital image 1000, the gradient image 1002 or both. Generally, connected component analysis employs one or more thresholds (e.g., distance thresholds, connection thresholds, and so on) to determine which edges or components of the digital image 1000, the gradient image 1002 or both are to be merged together as part of an object. Prior to performing connected component analysis, the digital image 1000, the gradient image 1002 or both are binarized using, for example, thresholding of the digital image 1000, the gradient image 1002 or both with an adaptive thresholding algorithm.

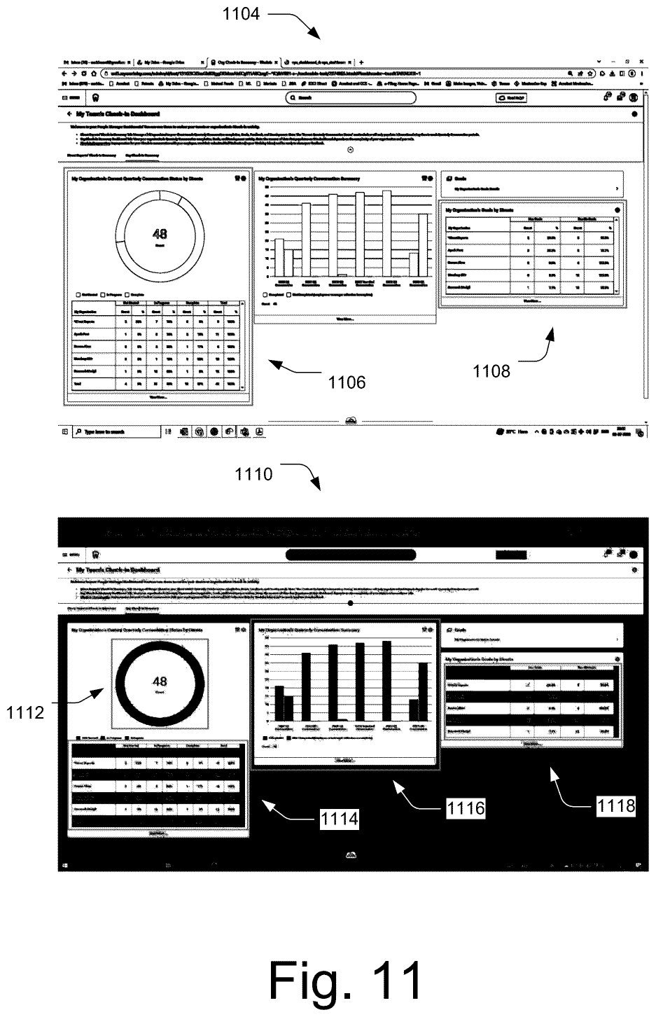

FIG. 11 shows a binarized gradient image 1104 created by binarizing the gradient image 1002 of FIG. 10. As can be seen, two objects 1106, 1108 have been identified and are provided with bounding boxes using connected component analysis. FIG. 11 also shows a binarized grey scale image 1110. The binarized grey scale image 1110 is created by computing a grey scale (not shown) image from the digital image 1000 and then binarizing the grey scale image. As can be seen, four (4) objects 1112, 1114, 1116 and 1118 have been identified and are provided with bounding boxes using connected component analysis of the binarized grey scale image 1110. At least three (3) of the objects 1112, 1114, and 1118 are objects within the objects 1106, 1108 previously identified.

### Line Segment Structure Detection

In one or more implementations, line segment structure detection is employed for aiding in identification and/or bounding of objects of a digital image in accordance with techniques described herein. Generally, line segment structure detection includes computing straight line segments of the digital image and computing a probability of those line segments as being part of an object. In this way, line segment structure detection is used to help define the structure of one or more objects of a digital image. With reference to FIG. 9, line segment structure detection is performable by the line segment module 902 to produce line segment images 908.

As an example of line segment structure detection, a machine learning model is trained and retrained to compute line segments of the digital image. The machine learning model can be trained with hundreds or even thousands of real and/or synthetic images. In the example, the machine learning model is a convolutional neural network that includes a plurality (e.g., 4, 6, 8, 10, 12, 14, 16 or more) of convolution layers and a plurality (e.g., 3, 5, 7 or more) of skip connection layers. The convolution layers include a plurality (e.g., 4, 6, 8 or more) of encoder layers and a plurality (e.g., 4, 6, 8 or more) of decoder layers. The layers of the machine-learning model are configured to determine the probability of pixels of the digital image belonging to line segments of the digital image. Pixels having a relatively high probability of belonging to line segments (e.g., a probability above a defined threshold) are deemed foreground pixels while the pixels having a relative low probability belonging to line segments (e.g., a probability below the threshold) are deemed background pixels.

The example machine-learning model implements one or more loss functions selected, e.g., a distance loss function, a group loss function and/or a fuzz loss function. The distance loss function, when included, identifies pixels having a likelihood of having been improperly identified as foreground pixels based on the distance of those identified pixels from other foreground pixels or having been improperly identified as background pixels based on the distance of those identified pixels from other background pixels. The distance loss function then applies loss to the identified pixels since the identified pixels are more likely to be improperly identified as foreground or background pixels. The group loss function, when included, identifies pixels that are adjacent to (e.g., neighboring) each other and have a likelihood of having been improperly identified as background pixels. The group loss function then applies loss to the identified adjacent pixels since the identified adjacent pixels are more likely to be improperly identified as background pixels. In one or more implementations, the degree of loss applied by the group loss function can be increased based on the number of adjacent pixels identified. The fuzz loss function, when included, identifies pixels as being either foreground pixels or background pixels. The fuzz loss function enhances the probability and/or visibility of foreground pixels (referred to as fuzz loss internal) while lowering the probability and/or visibility of background pixels (referred to as fuzz loss external). In turn, this fuzz loss function aids in determining document structures of objects of the digital image.

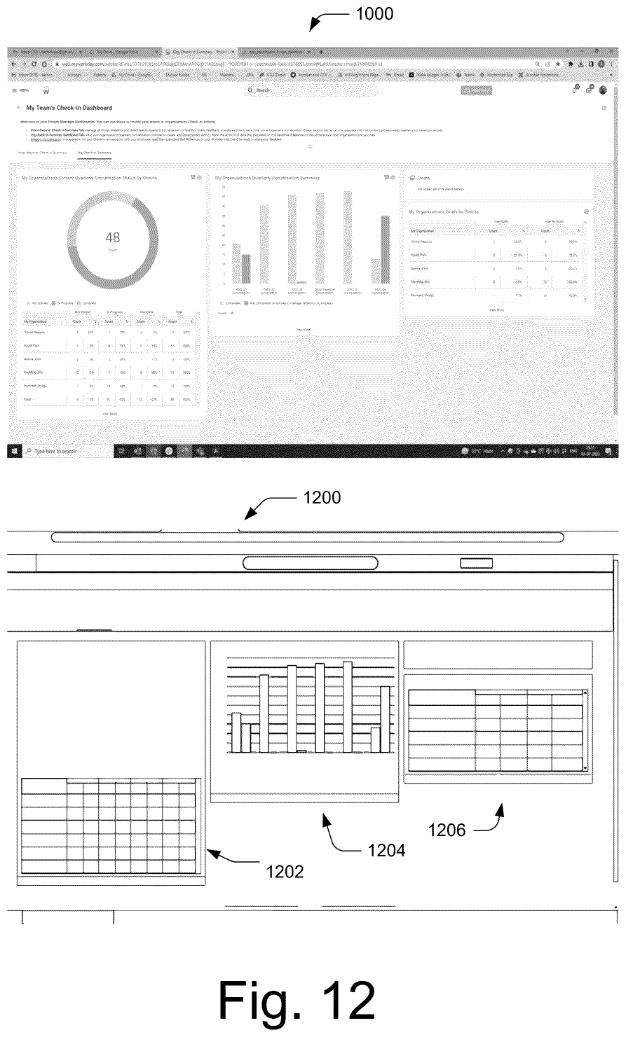

Generally, line segment structure detection results in one or more line segment structure images that specify lines structures of one or more objects of the digital image. FIG. 12, for example, illustrates a line segment structure image 1200 that was formed from the digital image 1000 of FIG. 10, which is reproduced in FIG. 12. The line segment structure image 1200 provides structure of three objects 1202, 1204, 1206 from the digital image 1000. The line segment structure image 1200 is created using a machine-learning model having eight (8) encoder layers, eight (8) decoder layers and seven (7) skip connection layers to compute the line segments of the object 1202, 1204, 1206. Further, a distance loss function, a group loss function and a fuzz loss function are employed to improve line segment computation of the objects 1202, 1204, 1206.

### Color-Based Segmentation

In one or more implementations, color-based segmentation is employed to aid in determining objects of a digital image in accordance with techniques described herein. Color-based segmentation can be directly applied to a digital image, however, other processing steps may be applied to the digital image prior to color-based segmentation. For example, a filter may be applied to a digital image for removing noise from the digital image. As another example, a grey-scale image is computed from the digital image followed by color-based segmentation. When performed, computation of the grey-scale image is performed on the original digital image or on the digital image after filtering noise from the digital image. The segmentation of the digital image is performed in one or more examples after noise removal and/or computation of the grey-scale image and is applied using a machine learning model. Color based segmentation is performed by the color-based segmentation module 904 of FIG. 9 but may alternatively be performed by alternative modules and/or alternative techniques.

Generally, color-based segmentation is a process of assigning a label to pixels (e.g., every pixel or a sub-set of pixels) of a digital image based upon characteristics, particularly color and/or shading, of the pixels. The pixels with the same labels are grouped together to create a color-based segmentation map that identifies and masks objects of the digital image. The masks are generally different colors but may also be implemented using different shades of grey.

In one or more implementation, the machine-learning model is implemented using a convolutional neural network that is trained to perform the color-based image segmentation on a digital image. The machine learning model includes a contracting path and an expanding path. The contracting path is configured to perform a plurality of convolutions for downsampling features of the digital image and the expanding path performs a plurality of convolutions for upsampling features of the digital image. Then semantic segmentation is used to associate the labeled pixels with respective objects and provides color-based or grey masks to the objects thereby identifying the boundaries of the objects in the color-based segmentation map.

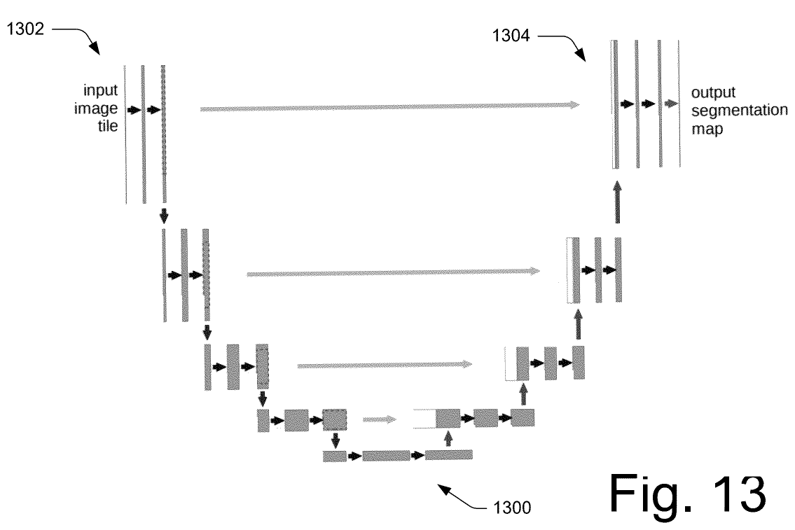

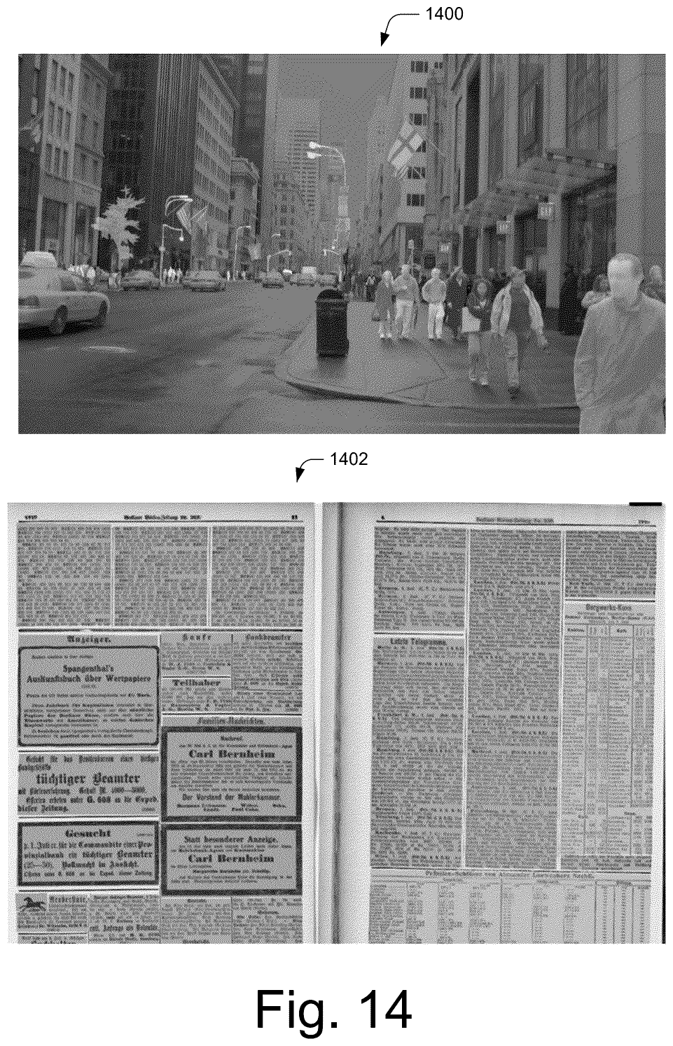

FIG. 13 illustrates an example of a network architecture 1300 of a machine-learning model suitable for performing color-based segmentation on a digital image. The architecture includes a contracting path 1302 and an expanding path 1304. The contracting path 1302 supports repeated application of two “3×3” unpadded convolutions to the digital image with each convolution followed by a rectified linear unit (ReLU) operation and a “2×2” max pooling operation with stride of “2” for downsampling. At each downsampling step, the number of feature channel is doubled. The expanding path 1304 supports upsampling of the digital image followed by a “2×2” convolution that halves output of the feature channel, a concatenation with a correspondingly cropped feature map from the contracting path, and two 3×3 convolutions, each followed by a ReLU. At the final illustrated layer, a “1×1” convolution is used to map each 64-component feature vector to the desired number of classes. The example network has twenty-three convolutional layers. Input tile size is also selectable such that the “2×2” max-pooling operation are applied to a layer with an even “X” and “Y” size to support tiling of an output segmentation map. Semantic segmentation is then applied to the digital image to assign pixel level masking of the objects in the digital image. FIG. 14 illustrates segmentation maps 1400, 1402 of two digital images upon which color-based segmentation is performed.

### Object Association

In one or more implementations, object association is employed to aid in determining object associations within a digital image in accordance with techniques described herein. Object association is a process of associating a first object (e.g., text) of a digital image with a second object (e.g., a graphic) of a digital image to form a link between the first and second object. The object associations are then usable as a basis to support a variety of functionalities such that the linked objects can be bounded, selected, and/or moved together. Generally, object association includes determining locations of multiple objects in a digital image and associating a first object of the multiple objects with a second object of the multiple objects based upon a first location of the first object and a second location of a second object. Once this object association is established, the first object and the second object can be bounded, selected and/or moved together as third or combination object, automatically and without user intervention.

The first object and the second object in this example are associated with different object classes. As an example, a text object and graphic object can be brought together via an object association to form a combination as a text/graphic object. Thus, the first object can be from a first class and the second object can be from a second class and those classes can be determined in accordance with the segmentation operations discussed herein or otherwise.

FIG. 15 illustrates an example of a technique 1500 for performing object association. At block 1502, positional locations of a first class of objects (e.g., text objects) are determined. At block 1504, positional locations of a second class of objects (e.g., graphics objects) are determined. Once these positional locations are determined, at block 1506, the positional locations of the first class of objects are analyzed relative to the positional locations of the second class of objects. Based on this analysis, at block 1508, one or more links between one or more of the objects of the first class of objects and one or more of the objects of the second class of objects.

It is contemplated that the positional locations of the objects can be determined in various ways and at various different positions relative to the objects. As one example, the positional locations are established as central locations of the objects. In this example, a mathematical algorithm could be used to establish the central locations of the objects. Alternatively, for objects that have a bounding box, the centers of the bounding box could be used as the central locations.

Analysis of the positional locations of the objects of the first class of objects relative to the positional locations of the objects of the second class of objects can also be accomplished in various ways. The analysis may involve determining distances between positional locations of objects of the first class relative to positional locations of objects of the second class. Then, objects of the first class are linked to objects of the second class based on proximity of the positional locations of the respective objects. For example, an algorithm can determine the distance of the positional location of an object of the first class relative to the positional locations of the objects of the second class to determine the object of the second class that is closest or closer to object of the first class relative to the rest of the objects of the second.

The algorithm then establishes a link between the object of the first class and the closest or closer object of the second class and link them together as an object that can be identified, bounded and or moved together. This analysis can then continue for other objects of the first and/or second class. Notably, it may be desirable to set one or more boundaries or thresholds on establishing these links between objects. For example, and without limitation, a threshold distance between positional locations of the objects may be established such that a distance between an object of the first class must be within the threshold distance of an object of the second class for a link to be established between the objects.

### Identifying, Bounding and Moving Operations

It is contemplated that any combination of the techniques described herein for parsing and segmenting objects of a digital image may be employed to help identify the various objects of the digital image. Without limitation, this includes any combination of the following: (1) instance segmentation; (2) patch structure identification; (3) gradient analysis; (4) structure analysis; (5) color-based segmentation; and/or (6) object association as described above. Each of these techniques provide information that is useful in identifying objects in a digital image and establishing to outer boundaries and/or internal structures of those objects.

Generally, the objects of a digital image are identified using an algorithm that receives, as input, the outputs from the various parsing and segmenting techniques. For example, techniques such as instance segmentation, color-based segmentation, and object association can be used to identify and classify objects of a digital image and techniques such as patch structure identification, gradient analysis and structure analysis can be employed to identify objects that are components of other objects and help establish edges and boundaries of the objects.

During or after identification of the objects, the objects that are identified may be bound together, although not required unless otherwise stated. With reference to FIG. 2, the bounding module 220 may be employed to bound objects and provide the bound objects with bounding indications. Bounding of the objects refers to, in one or more examples, providing one or more bounding indications as visual guides usable to identify the objects of the digital image. Examples of bounding indications 124. 126 are described previously in relation to FIG. 1. The term “bounding indications” includes any highlighting, coloring, markings, or otherwise visual technique usable to provide a user with indications of the location and/or outer boundaries of an object. Such bounding indications may be shown or visible as desired to help identify the objects of a digital image and the use of such bounding indications will typically depend upon how the objects being identifies by the bounding indications are being manipulated.

Generally, objects are identified and/or bounded herein so that the objects are movable or other manipulable relative to digital images, within which, the objects reside. For example, an object may be moved within a digital image (e.g., from one location in a digital image to another location in the digital image), from one digital image to another, or otherwise. In an implementation, an object within a digital image is located within a user interface either before, during, or after objects of the digital image are identified and/or bounded using techniques described herein.

Once the objects have been identified and provide with bounding indications, the objects can then be manipulated. For example, the bounding indications may become visible as a user performs a mouse-over of the digital image such that the user knows the object indicated by the bounding indications can be selected and manipulated. A user can then select the object and move the object as desired.

Whether the objects include bounding indications or not, editing (e.g., movement) of objects can performed with the digital operation module 128 identified in FIG. 2 or by other modules.

In one or more implementations, the bounding indication is provided to aid in a snapping operation 224 involving movement of one object relative to another object. As used herein, the term “snap” and its conjugations refer to moving an object into alignment with another entity with the computer aiding in that alignment based upon identified locations of the object and entity and proximity of the objects in relation to each other. The other object is configurable in a variety of ways, such as a gridline of a grid or otherwise. In a snap operation, at least one location (e.g., a point) of the object that is to be moved is identified (e.g., by its bounding) and aligned with a location (e.g., a point) on the other entity. The locations may be aligned, for example, based on visual guides output as part of the operation. A connector (e.g., a dashed line), for instance, appears as a visual guide at least temporarily interconnecting the location of the object with a location of the entity when the object is close to being aligned with the entity (i.e., within a threshold distance from being aligned). When the connector appears, the user releases the object that is being moved and the object is automatically relocated as in alignment with the entity, i.e., is moved to a location supporting alignment between the objects. As an example, an input is received to select (e.g., “click” and hold) and then move a first object relative to a second object until a location (e.g., an upper or lower location) of the first object is aligned or near aligned with a location (e.g., an upper or lower location) of the second object. When a connector appears between the location of the first object and the location of the second object, an input is received to deselect (e.g., “unclick” off) the first object and the first object is automatically positioned to align the location of the first object with the location of the second object.

It shall be understood that moving, snapping, or otherwise manipulating objects can be undertaken for single objects relative to each other as well as combination objects where one object is associated with another object. Thus, an object that is manipulated in accordance with techniques described herein can be a singular object or a combination object.

It is further contemplated that alternative alignment operations 226 can be performed on objects as well. Visual alignments can be performed by user that moves an object from one digital image to a different digital image. In such an operation, the bounding indications help define the outer boundaries of the object to provide indication as to where an object is being moved and if the object will “cover” other portion of a digital image. In addition, or as an alternative to the bounding indications, visual guides are employed to identify the outer boundaries of an object that is being moved. For example, temporary line segments are formable to extend outward from an object and those line segments may expand or shrink based on how close the object being moved is relative to other objects. Other examples are also contemplated.

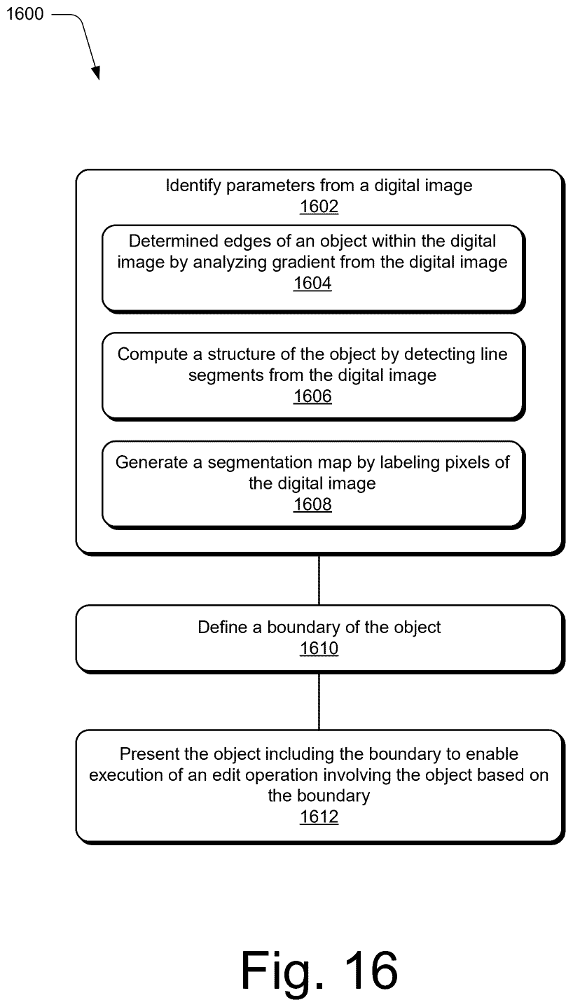

FIG. 16 is a flowchart of an example of a methodology 1600 for performing an edit operation based on a defined boundary of an object in a digital image. To begin in this example, parameters are identified from a digital image (block 1602).

The parameters, for instance, are usable as a basis to define a boundary of an object, e.g., a raster object, a vector object, or other collection of pixels. A variety of parameters may be utilized in various combinations, including two or more of the following examples.

In a first example, edges of an object are determined within a digital image by analyzing gradients from the digital image (block 1604). In a second example, a structure of the object is computed by detecting line segments from the digital image (block 1606). In a third example, a segmentation map is generated by labeling pixels of the digital image (block 1608). Any two or more of these examples are usable, in one or more scenarios, as parameters which are then used to define a boundary of the object (block 1610). The object including the boundary is presented for display on a user interface, thereby enabling execution of an edit operation involving the object based on the boundary (block 1612), e.g., output of visual guides, a snapping operation, selection operation involving multiple linked objects, and so on. A variety of other examples are also contemplated as described above.

### Example System and Device

FIG. 17 illustrates an example system 1700 that includes an example computing device 1702 that is representative of one or more computing systems and/or devices that are usable to implement the various techniques described herein. This is illustrated through inclusion of the system 200 from FIG. 2 in FIG. 17, which can include the viewpoint location module and a viewpoint determination module. The computing device 1702 includes, for example, a server of a service provider, a device associated with a client (e.g., a client device), an on-chip system, and/or any other suitable computing device or computing system.

The example computing device 1702 as illustrated includes a processing system 1704, one or more computer-readable media 1706, and one or more I/O interfaces 1708 that are communicatively coupled, one to another. Although not shown, the computing device 1702 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1704 is representative of functionality to perform one or more operations using hardware. Accordingly, the processing system 1704 is illustrated as including hardware elements 1710 that are configured as processors, functional blocks, and so forth. This includes example implementations in hardware as an application specific integrated circuit or other logic device formed using one or more semiconductors. The hardware elements 1710 are not limited by the materials from which they are formed, or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 1706 is illustrated as including memory/storage 1712. The memory/storage 1712 represents memory/storage capacity associated with one or more computer-readable media. In one example, the memory/storage 1712 includes volatile media (such as random access memory (RAM)) and/or nonvolatile media (such as read only memory (ROM), Flash memory, optical disks, magnetic disks, and so forth). In another example, the memory/storage 1712 includes fixed media (e.g., RAM, ROM, a fixed hard drive, and so on) as well as removable media (e.g., Flash memory, a removable hard drive, an optical disc, and so forth). The computer-readable media 1706 is configurable in a variety of other ways as further described below.

Input/output interface(s) 1708 are representative of functionality to allow a user to enter commands and information to computing device 1702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1702 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 1702. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 1702, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1710 and computer-readable media 1706 are representative of modules, programmable device logic and/or fixed device logic implemented in a hardware form that is employable in some embodiments to implement at least some aspects of the techniques described herein, such as to perform or be responsive to one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by and/or responsive to instructions and/or logic embodied by the hardware as well as a hardware utilized to store instructions for causing execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 1710. For example, the computing device 1702 is configured to implement particular instructions and/or functions corresponding to the software and/or hardware modules. Accordingly, implementation of a module that is executable by the computing device 1702 as software is achieved at least partially in hardware, e.g., through use of computer-readable storage media and/or hardware elements 1710 of the processing system 1704. The instructions and/or functions are executable/operable by one or more articles of manufacture (for example, one or more computing devices 1702 and/or processing systems 1704) to implement techniques, modules, and examples described herein.

The techniques described herein are supportable by various configurations of the computing device 1702 and are not limited to the specific examples of the techniques described herein. This functionality is also implementable entirely or partially through use of a distributed system, such as over a “cloud” 1714 as described below.

The cloud 1714 includes and/or is representative of a platform 1716 for resources 1718. The platform 1716 abstracts underlying functionality of hardware (e.g., servers) and software resources of the cloud 1714. For example, the resources 1718 include applications and/or data that are utilized while computer processing is executed on servers that are remote from the computing device 1702. In some examples, the resources 1718 also include services provided over the Internet and/or through a subscriber network, such as a cellular or Wi-Fi network.

The platform 1716 abstracts the resources 1718 and functions to connect the computing device 1702 with other computing devices. In some examples, the platform 1716 also serves to abstract scaling of resources to provide a corresponding level of scale to encountered demand for the resources that are implemented via the platform. Accordingly, in an interconnected device embodiment, implementation of functionality described herein is distributable throughout the system 1700. For example, the functionality is implementable in part on the computing device 1702 as well as via the platform 1716 that abstracts the functionality of the cloud 1714.

### CONCLUSION

Although implementations of systems for determining viewpoints of three-dimensional objects have been described in language specific to structural features and/or methods, it is to be understood that the appended claims are not necessarily limited to the specific features or methods described. Rather, the specific features and methods are disclosed as example implementations of systems for determining viewpoints of three-dimensional objects, and other equivalent features and methods are intended to be within the scope of the appended claims. Further, various different examples are described, and it is to be appreciated that each described example is implementable independently or in connection with one or more other described examples.

What is claimed is:

1. A method comprising:
determining, by a processing device, edges of an object within a digital image by analyzing gradients from the digital image;
computing, by the processing device, a structure of the object by detecting line segments from the digital image;
defining, by the processing device, a boundary of the object based on the edges and the structure; and
presenting, by the processing device, the object including the boundary to enable execution of an edit operation involving the object based on the boundary.

2. The method of claim 1, further comprising generating, by the processing device, a segmentation map from the digital image, the generating performed by labeling pixels of the digital image and wherein the defining of the boundary is based on the segmentation map, the boundary, and the structure.

3. The method of claim 2, wherein the generating the segmentation map from the digital image is performed by a machine learning model that includes:
a contracting path that performs a plurality of convolutions for down-sampling features of the digital image; and
an expanding path that performs a plurality of convolutions for upsampling features of the digital image.

4. The method of claim 1, wherein the edit operation is a snapping operation.

5. The method of claim 1, further comprising generating an instance segmentation map by performing instance segmentation using the digital image, and wherein the defining the boundary of the object is based on the edges, the structure, and the instance segmentation map.

6. The method of claim 1, further comprising generating a feature map that includes a mask identifying the object by performing patch structure identification on the object of the digital image, and wherein the defining the boundary of the object is based on the edges, the structure, and the feature map.

7. The method of claim 1, wherein the determining the edges of the object includes convolving the digital image with a filter.

8. The method of claim 1, wherein the computing the structure of the object is performed with a machine learning model implementing one or more loss functions selected from a distance loss function, a group loss function, or a fuzz loss function.

9. A computing device comprising:
a processing device; and
a computer-readable storage medium storing instructions that, responsive to execution by the processing device, causes the processing device to perform operations including:
receiving a selection of a first object displayed in a user interface;
identifying a link between the first object and a second object, the identifying based on a first positional location associated with the first object in the user interface and a second positional location associated with the second object in the user interface;
receiving a movement input specifying movement of the first object in the user interface; and
controlling movement of the second object based on the movement input, the movement of the second object controlled as following movement of the first object in the user interface based on the link.

10. The computing device of claim 9, wherein the first object and the second object are separately selectable in the user interface.

11. The computing device of claim 9, wherein the first object is a text object or a graphic object and the second object is a text object if the first object is a graphic object or a graphic object if the first object is a text object.

12. The computing device of claim 9, wherein the first positional location is a central location of the first object and the second positional location is a central location of the second object.

13. The computing device of claim 9, wherein the identifying of the first object location includes defining a boundary of the first object, the defining including:
determining edges of the first object by analyzing gradients from a digital image;
computing a structure of the first object by detecting line segments from the digital image; and
generating a segmentation map from the digital image, the generating performed by labeling pixels of the digital image.

14. The computing device of claim 9 wherein the identifying the link between the first object and the second object includes:
determining locational positions of objects of a first class and locational positions of objects of a second class, the first positional location being one of the locational positions of the objects of the first class, the second positional location being one of the locational positions of the objects of the second class, and determining that the first positional location is closer to the second positional location than the first positional location is relative to any other of the other positional locations of the objects of the second class.

15. A method comprising:
computing, by a processing device, a structure of an object of a digital image by detecting line segments from the digital image;
generating, by the processing device, a segmentation map from the digital image, the generating performed by labeling pixels of the digital image;
defining, by the processing device, a boundary of the object based on the structure and the segmentation map; and
presenting, by the processing device, the object including the boundary to enable execution of an edit operation involving the object based on the boundary.

16. The method of claim 15, further comprising determining edges of the object within the digital image by analyzing gradients from the digital image and wherein the defining is based on the edges, the structure, and the structure.

17. The method of claim 15, further comprising generating an instance segmentation map by performing instance segmentation using the digital image, and wherein the defining the boundary of the object is based on the structure, the segmentation map, and the instance segmentation map.

18. The method of claim 15, further comprising generating a feature map that includes a mask identifying the object by performing patch structure identification on the object of the digital image, and wherein the defining the boundary of the object is based on the segmentation map, the structure, and the feature map.

19. The method of claim 15, wherein the computing the structure of the object is performed with a machine learning model implementing one or more loss functions selected from a distance loss function, a group loss function, or a fuzz loss function.

20. The method of claim 15, wherein the generating the segmentation map from the digital image is performed by a machine learning model that includes:
a contracting path that performs a plurality of convolutions for down-sampling features of the digital image; and
an expanding path that performs a plurality of convolutions for upsampling features of the digital image.
